(19) United States
(12) Patent Application Publication
(10) Pub. No.: US 2026/0205637 A1
(43) Pub. Date: Jul. 16, 2026

(54) METHOD AND SYSTEM FOR CROSS-SOCIAL MEDIA LIVESTREAMING

(71) Applicants: Yi-Chih LU, Taipei City (TW); BRAVO IDEAS DIGITAL CO., LTD., Tortola (VG)

(72) Inventor: Yi-Chih LU, Taipei City (TW)

(73) Assignees: Yi-Chih LU, Taipei City (TW); BRAVO IDEAS DIGITAL CO., LTD., Tortola (VG)

(21) Appl. No.: 19/221,703

(22) Filed: May 29, 2025

(30) Foreign Application Priority Data
Jan. 16, 2025 (CN) 202510068299.2

(51) Int. Cl. H04N 21/2187; G06Q 30/0601; G06Q 50/00; H04N 21/254; H04N 21/431; H04N 21/442; H04N 21/4725; H04N 21/4788; H04N 21/658

(52) U.S. Cl. CPC H04N 21/2187; G06Q 10/40; G06Q 30/0633; H04N 21/2542; H04N 21/4316; H04N 21/44204; H04N 21/4725; H04N 21/4788; H04N 21/6581

(57) ABSTRACT

A method for cross-social media livestreaming is implemented by a livestream device that is in intercommunication with a server and that is operated by a livestream host. The method includes steps of: logging in to the server and a plurality of social media platforms; obtaining an image dataset for generating a product image of a product being sold, and a Uniform Resource Locator (URL) of a webpage for purchasing the product, and displaying through a control interface the product image and the URL; obtaining an audio-video dataset for generating a video with audio, and displaying the video through the control interface; transmitting the image dataset, the URL and the audio-video dataset to the server to livestream a streaming media on the plurality of social media platforms; and receiving a communication dataset obtained by the server and for generating a viewer comment, and displaying the viewer comment through the control interface.

### CROSS-REFERENCE TO RELATED APPLICATION

This application claims priority to Chinese Invention Patent Application No. 202510068299.2, filed on Jan. 16, 2025, the entire disclosure of which is incorporated by reference herein.

### FIELD

The disclosure relates to a method and a system for livestreaming, and more particularly to a method and a system for cross-social media livestreaming.

### BACKGROUND

With developments in livestreaming technology, livestreaming has set off a new trend around the world. According to data, the conversion rate of livestreaming e-commerce is more than ten times higher than that of traditional e-commerce. Therefore, many well-known social media platforms, such YouTube Live, Facebook, X (formerly Twitter), Instagram and TikTok, are actively entering the field of e-commerce livestreaming.

Although most people are familiar with livestreaming, livestream hosts are still limited by the services provided by social media, the vast number of social media platforms, insufficient livestreaming equipment and limited human resources, causing inconvenience for livestream hosts.

For example, Taiwanese Patent No. I674801B provides, referring to FIG. 1, a conventional method of livestreaming mainly uses a user-end device 11 (e.g., smartphone, laptop, desktop computer) that belongs to a livestream host and that is logged in to a server-end device 2 of a social media platform (e.g., Facebook) to obtain and transmit to the server-end device 2 a live video with audio. The server-end device 2 can then livestream the live video to a plurality of member devices 3 (e.g., smartphones) that belong to multiple viewers through the social media platform. Throughout the livestream, viewer comments can be transmitted to the server-end device 2 through the member devices 3. Another user-end device 12 can be used by the livestream host to reply to the viewer comments so as to interact with the viewers.

Since viewers and the livestream host can interact only through the viewer comments, the following problems may arise when a viewer has a desire to purchase a product being sold through the livestream:
1. The viewer will need to leave a viewer comment stating the product they wish to purchase (e.g., by leaving a private message on the social media platform). After the livestream ends, the livestream host or an assistant of the livestream host will need to privately contact the viewer to obtain information for completing the transaction of purchasing the product. This process is not only labor-intensive and time-consuming, but is also uneconomical.
2. In an example of the server-end device 2 providing the social networking service of Facebook, a stream key needs to be obtained from Facebook in order for the live video to be livestreamed on Facebook. Therefore, the livestream host will need to use the user-end device 11 to log in to Facebook and livestream the live video through Facebook, or to livestream the live video through Facebook after entering the obtained stream key into a computer installed with Open Broadcaster Software (OBS). Being limited by the stream key, only users on Facebook will be able to view the live video, and the livestream host will only be able to interact with the users on Facebook, which creates a technical barrier to increasing the number of viewers.

Referring to FIGS. 1 and 2, in order to alleviate the aforementioned technical barrier to increasing the number of viewers, during livestreaming, a plurality of user-end devices 11 logged respectively in to different social media platforms may be used to record the livestream host to simultaneously obtain multiple live videos and livestream the live videos on the social media platforms, and a plurality of user-end devices 12 may be used to reply to viewer comments. In this way, the number of viewers can increase.

However, the user-end devices 11 used for livestreaming and the user-end devices 12 used for replying to viewer comments can quickly amount to a large number of devices that need to be operated by the livestream host. In an example of livestreaming the live videos on three different social media platforms, the livestream host will need to prepare six user-end devices 11, 12, where three of the user-end devices 11 are used for obtaining the live videos and another three of the user-end devices 12 are used for viewing and replying to viewer comments. When livestreaming the live videos on six different social media platforms, the livestream host will need to prepare twelve user-end devices 11, 12. As can be seen, not only is the cost of equipment high, equipment operation can also be difficult for the livestream host. Since viewer comments are displayed on various social media platforms, there could be issues of missing viewer comments or not having time to reply to viewer comments.

### SUMMARY

Therefore, an object of the disclosure is to provide a method and a system for cross-social media livestreaming that can alleviate at least one of the drawbacks of the prior art.

According to an aspect of the disclosure, the method for cross-social media livestreaming is to be implemented by a livestream device that is in intercommunication with a server and that is operated by a livestream host. The method includes steps of: logging in to the server and to a plurality of social media platforms by identifying the livestream host, so as to gain permission to access the server and the plurality of social media platforms; obtaining an image dataset to be used for generating a product image of a product being sold, and a Uniform Resource Locator (URL) of a webpage for purchasing the product, and displaying the product image and the URL through a control interface, the image dataset and the URL being configured to represent a streaming media; obtaining an audio-video dataset to be used for generating a video with audio, and displaying the video through the control interface, the audio-video dataset being configured to represent the streaming media; transmitting the image dataset, the URL and the audio-video dataset to the server for the server to livestream the streaming media on the plurality of social media platforms, so as to enable a plurality of electronic devices to browse the streaming media through the plurality of social media platforms; and receiving a communication dataset obtained by the server and to be used for generating a viewer comment, and displaying the viewer comment through the control interface, the communication dataset being transmitted to the server by one of the plurality of electronic devices through one of the plurality of social media platforms, the viewer comment including text, one or more symbols, one or more links, one or more graphics, or combinations thereof.

According to another aspect of the disclosure, the system for cross-social media livestreaming is adapted to be used for livestreaming a streaming media through a plurality of social media platforms. The system includes a server and a livestream device. The server is used for livestreaming the streaming media on the plurality of social media platforms. The livestream device is configured to be in intercommunication with the server and to be operated by a livestream host, and to implement the aforementioned method.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating a conventional architecture for livestreaming.

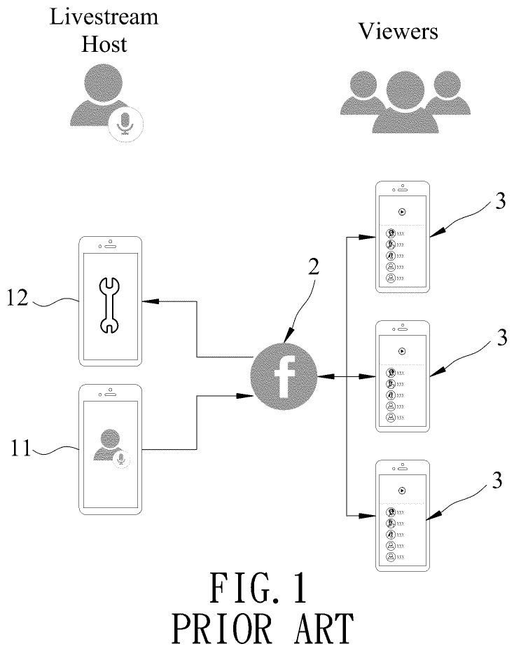

FIG. 2 is a schematic view illustrating another conventional architecture for livestreaming.

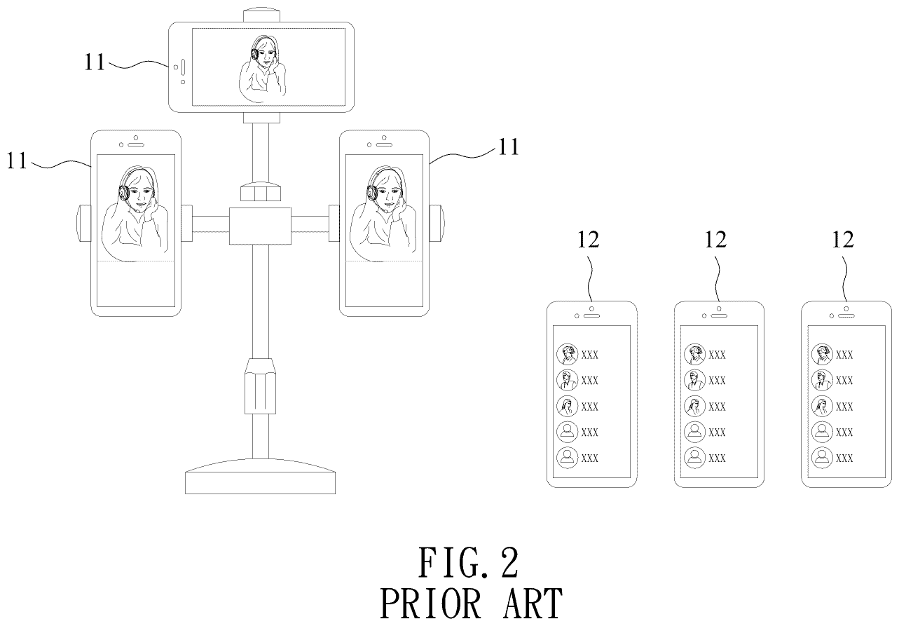

FIG. 3 is a schematic view illustrating a system for cross-social media livestreaming according to an embodiment of the disclosure.

FIG. 4 is a block diagram illustrating the system for cross-social media livestreaming according to an embodiment of the disclosure.

FIG. 5 is a schematic view illustrating a streaming media being livestreamed on a plurality of social media platforms through a proxy key and a proxy address according to an embodiment of the disclosure.

FIG. 6 is a schematic view illustrating a control interface according to an embodiment of the disclosure.

FIG. 7 is a schematic view illustrating a transaction webpage according to an embodiment of the disclosure.

FIG. 8 is a schematic view illustrating the control interface displaying a video traffic report and a sales report according to an embodiment of the disclosure.

FIG. 9 is a flow chart of a method for cross-social media livestreaming according to an embodiment of the disclosure.

FIG. 10 is a schematic view illustrating the control interface and a plurality of electronic devices simultaneously livestreaming the streaming media according to an embodiment of the disclosure.

FIG. 11 is a flow chart illustrating steps of transmitting data that represents the streaming media to a server according to an embodiment of the disclosure.

FIG. 12 is a schematic view illustrating a livestream host comment being selected to be livestreamed to a selected one or more of the social media platforms according to an embodiment of the disclosure.

FIG. 13 is a schematic view illustrating a system for cross-social media livestreaming according to another embodiment of the disclosure.

FIG. 14 is a schematic view illustrating a first video and a second video that is superimposed on the first video on one of the electronic devices according to an embodiment of the disclosure.

FIG. 15 is a schematic view illustrating a product image, a viewer comment, a livestream host comment and a transaction code being superimposed on the first video on one of the electronic devices according to an embodiment of the disclosure.

FIG. 16 is a schematic view illustrating a system for cross-social media livestreaming according to another embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

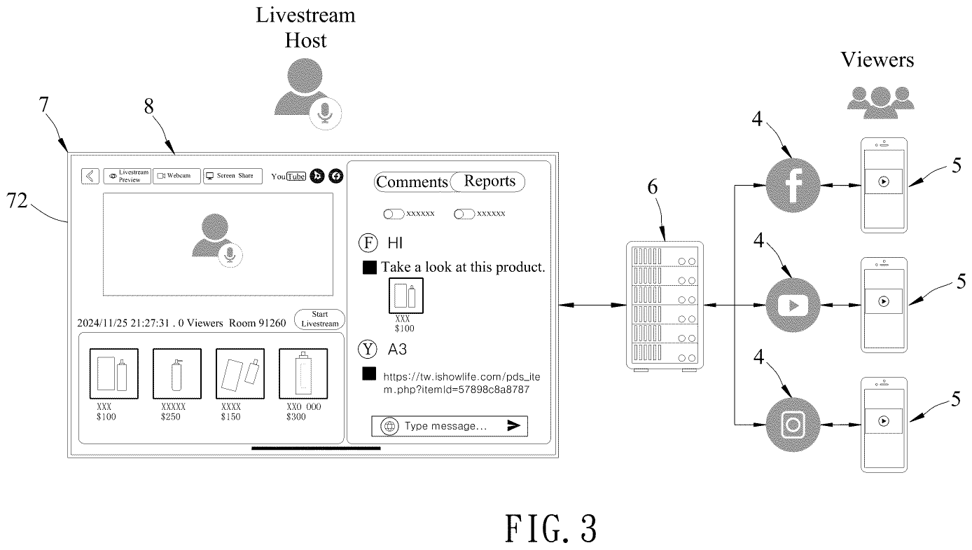

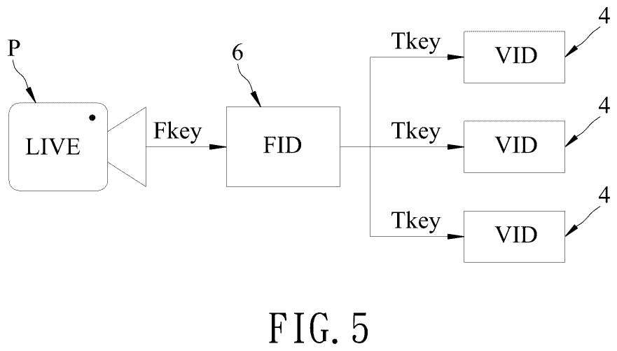

Referring to FIGS. 3 to 5, a system for cross-social media livestreaming according to an embodiment of the disclosure is adapted for livestreaming a streaming media (S) to a plurality of electronic devices 5 through a plurality of social media platforms 4. The system for cross-social media livestreaming includes a server 6, and a livestream device 7 that belongs to a livestream host.

For example, the social media platforms 4 include, but are not limited to, YouTube, Facebook, X (formerly Twitter), Instagram or TikTok. Each of the social media platforms 4 can, in response to a request from a livestream push end (e.g., a smart phone operating by a livestream host), return data such as a platform address (VID) and a stream key (Tkey) to the livestream push end. The platform address (VID) is for livestreaming a streaming media, and the stream key (Tkey) allows the livestream push end to obtain permission to transmit a streaming media to the platform address (VID).

Each of the electronic devices 5 represents a livestream pull end and belongs to a viewer of the streaming media (S). Each of the electronic devices 5 is configured to be used for inputting and outputting data and information and may be embodied as a smartphone, a portable computer, a desktop computer, or other devices capable of inputting and outputting data and information. Each of the electronic devices 5 is further configured to be able to establish connection with one of the social media platforms 4 and pull the streaming media (S), so as to receive data for representing the streaming media (S).

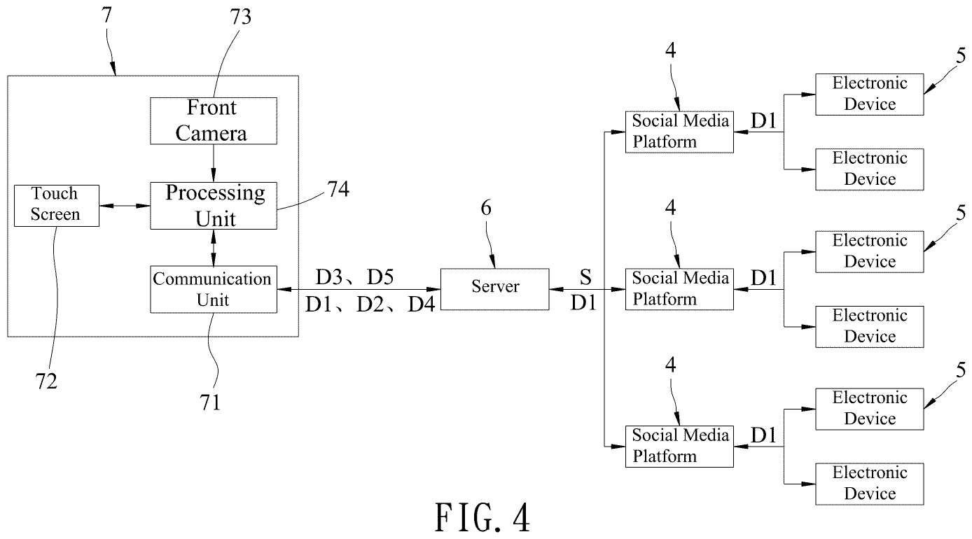

Referring to FIGS. 4 to 7, each electronic device 5 is further configured to transmit to one of the social media platforms 4, which the electronic device 5 is connected to, a communication dataset (D1) for generating one or more viewer comment(s) (M1), one or more transaction code(s) (M2), or a combination thereof. Each of the viewer comments (M1) includes, but is not limited to, text, one or more symbols, one or more links, or one or more graphics. Each of the transaction codes (M2) includes a first character (M21) corresponding to a product (not shown) being sold, and a second character (M22) corresponding to a purchase quantity. In the present embodiment, the first character (M21) is embodied as an English letter that is able to represent a sequence, and the second character (M22) is embodied as a numeral. The first character (M21) can be configured to come before the second character (M22), such as in “A1”, or to come after the second character (M22), such as in “2A”. The second character (M22) can also be configured to be spaced apart from the first character (M21) by a number of preset characters (e.g., one or more whitespace characters, one or more plus symbols, etc.), such as in “2 A”, “A 1”, “A+3”, etc.

The server 6 is configured to connect to the Internet for communication with other devices, and has relatively high computing power and a relatively large amount of storage space compared to the livestream device 7. The server 6 is not limited to a specific number of machines, but instead refers to equipment that can complete a large amount of work in a short period of time and provide services to a large number of users. Therefore, the server 6 can also be used as a general term for such equipment.

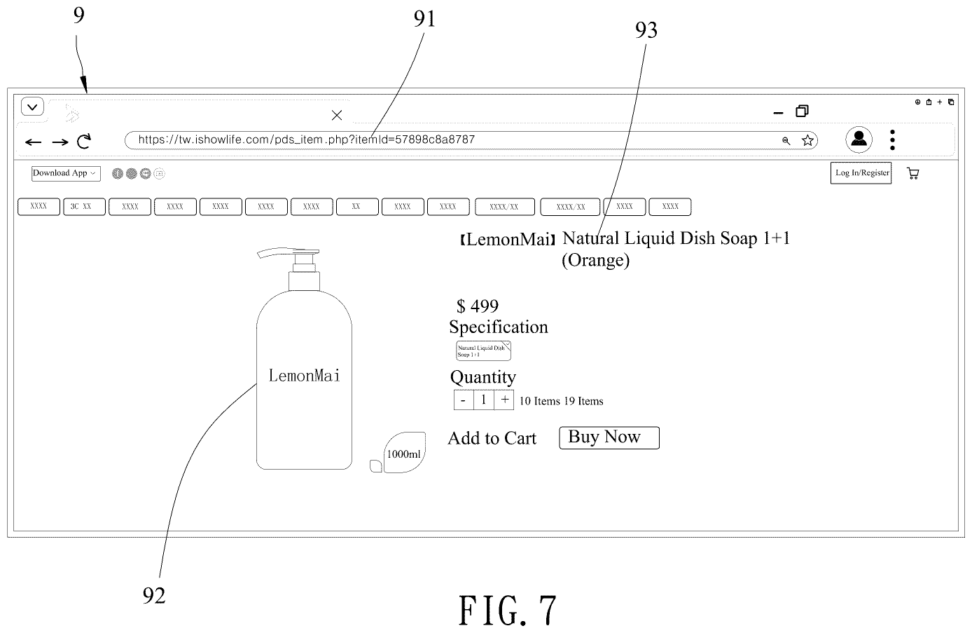

In one embodiment, the server 6 communicates with the social media platforms 4 through wireless communication technology to obtain and exchange the communication dataset (D1), build a shopping website, create a proxy address (FID), and generate a proxy key (Fkey) based on the proxy address (FID). The shopping website includes a plurality of transaction webpages 9 (one transaction webpage 9 is shown in FIG. 7 as an example). The location of each of the transaction webpages 9 is identified by a Uniform Resource Locator (URL) 91. Each of the transaction webpages 9 displays a product image 92 of the product and a set of product information 93. The set of product information 93 includes details such as, but not limited to, a product name of the product, a price of the product, etc. The set of product information 93 and the product image 92 of the product are generated using an image dataset (D2). The proxy key (Fkey) is used for obtaining permission to transmit the data for representing the streaming media (S) to the proxy address (FID).

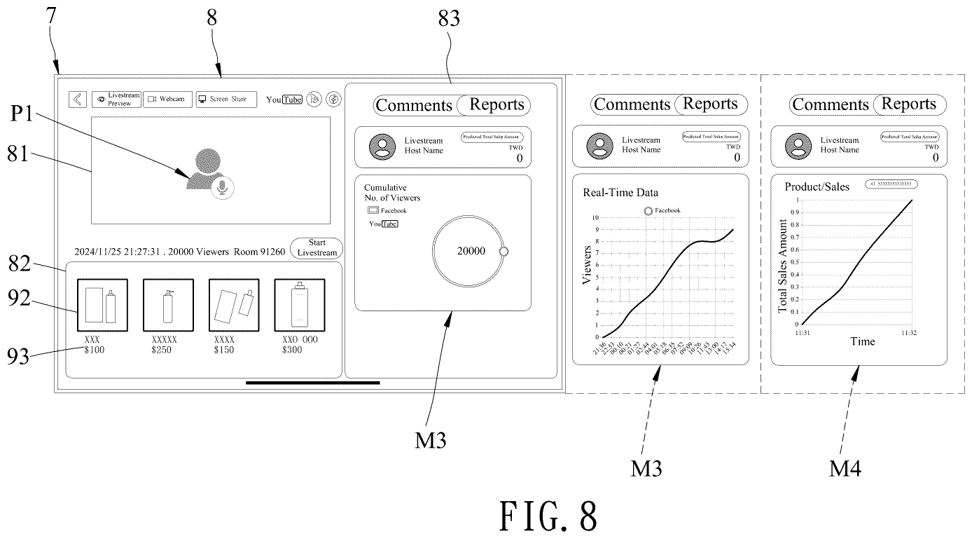

Referring to FIGS. 4, 6 and 8, the server 6 is configured to generate a video traffic report (M3) for presenting a number of people who viewed the streaming media (S) through each of the social media platforms 4. The video traffic report (M3) may be presented in the form of a pie chart or a line graph. In addition, the server 6 is further configured to generate a sales report (M4) for presenting a total sales quantity (i.e., total number of the product sold) and a total sales amount (i.e., total sales price of the product sold) of the product according to the communication dataset (D1). For example, the sever 6 is configured to execute an artificial intelligence model to generate the video traffic report (M3) and the sales report (M4). The server 6 is further configured to output a report dataset (D4) for generating the video traffic report (M3) and the sales report (M4) to the livestream device 7.

It is worth noting that the image dataset (D2) and the URL 91 are configured by the server 6 to represent the streaming media (S). Furthermore, the shopping website is not limited to being built on the server 6. In some embodiments, the shopping website may also be built on other servers (not shown) that are in intercommunication with the server 6. Furthermore, in the present embodiment, the sales report (M4) is generated by the server 6 identifying each time the first character (M21) of the transaction code (M2) appears and the purchase quantity corresponding to the second character (M22) following the first character (M21), so as to predict the total sales quantity and the total sales amount of the product.

Referring to FIGS. 4, 5 and 6, the livestream device 7 is configured to be used for inputting and outputting data and information, and may be embodied as a smartphone, a portable computer, a desktop computer, or other devices capable of inputting or outputting data and information. In the present embodiment, the livestream device 7 serves as the livestream push end, and is configured to obtain a first video (P1) with audio, output an audio-video dataset (D3) for generating the first video (P1), generate one or more livestream host comment(s) (M5) based on a feedback dataset (D5), and generate the video traffic report (M3) and the sales report (M4) based on the report dataset (D4). The livestream host comment (M5) includes, but is not limited to, text, one or more symbols, one or more links, or one or more graphics.

Since streaming media, push/up streaming and pull/down streaming are not main technical features of the disclosure, and details thereof can be expanded on by one with ordinary skills in the art based on the above description, further details will be omitted herein.

The livestream device 7 includes a communication unit 71, a touch screen 72 for displaying a control interface 8 and for inputting of information, a front camera 73 for obtaining the first video (P1), and a processing unit 74 electrically connected to the communication unit 71, the touch screen 72 and the front camera 73. In the present embodiment, the communication unit 71 intercommunicates with the server 6 through wireless communication technology. The processing unit 74 serves as a computing and control core for performing information processing and program execution. For example, the communication unit 71 may include one or more of a radio-frequency integrated circuit (RFIC), a short-range wireless communication module supporting a short-range wireless communication network using a wireless technology such as Bluetooth® and/or Wi-Fi, etc., and a mobile communication module supporting telecommunication using Long-Term Evolution (LTE), the third generation (3G), the fourth generation (4G) or the fifth generation (5G) of the wireless mobile telecommunications technology, or the like; the processing unit 74 may include, but is not limited to, one or more of a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), a system on a chip (SoC), etc.

The audio-video dataset (D3) and the feedback dataset (D5) are configured by the server 6 to represent the streaming media (S).

The livestream device 7 is further configured to transmit the feedback dataset (D5), inputted by the livestream host through the touch screen 72, to the server 6 through the communication unit 71.

It is worth noting that the feedback dataset (D5) is not limited to being inputted through the touch screen 72. In other embodiments, the feedback dataset (D5) may also be inputted through a keyboard or a smartphone in intercommunication with the livestream device 7.

The control interface 8 includes a video display area 81, a product preview area 82 and an information area 83. The video display area 81 is for playing video or audio. The product preview area 82 is for presenting the product image 92 and the set of product information 93. The information area 83 is for presenting information such as the viewer comments (M1), the transaction codes (M2), the video traffic report (M3), the sales report (M4) and the livestream host comment (M5).

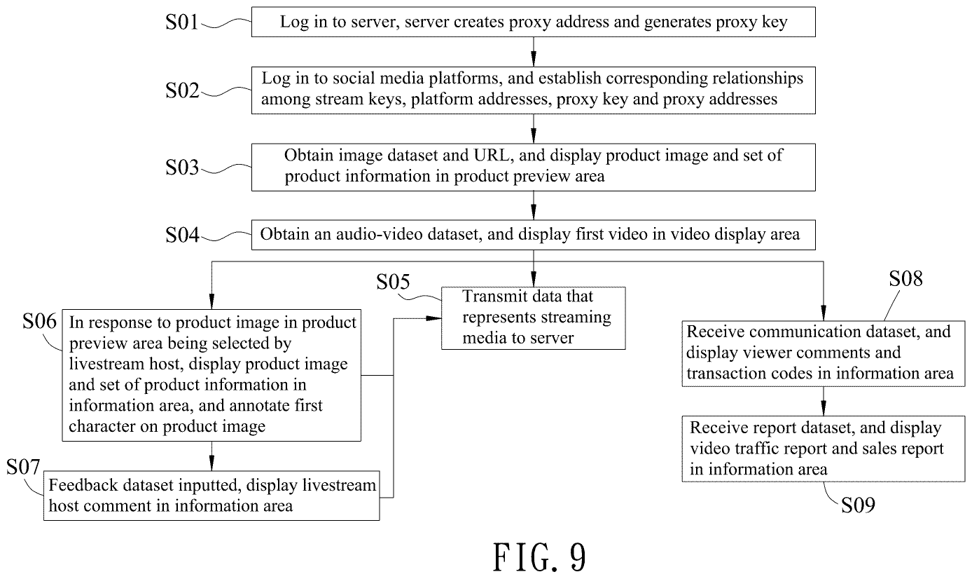

Referring to FIGS. 4, 5, 6 and 9, the system for cross-social media livestreaming according to embodiments of the disclosure establishing a livestream is initiated by the livestream host using the livestream device 7, and the processing unit 74 executes an application (Open Broadcaster Software) to implement a method for cross-social media livestreaming that includes the steps below.

In step S01, the livestream device 7 is logged in to the server 6 through verification to enable the livestream device 7 to be in intercommunication with the server 6, so as to gain permission for the livestream device 7 to access the server 6. Specifically, the livestream host uses the livestream device 7 to log in to the server 6 by inputting a user account and a password, and the server 6 verifies the user account and the password and allows the livestream device 6 to log in to when the user account and the password are verified to be correct; in response to the livestream device 7 logging in to the server 6, the server 6 is triggered to create the proxy address (FID) corresponding to the livestream host (i.e., corresponding to the user account), to generate the proxy key (Fkey) based on the proxy address (FID), and to transmit the proxy address (FID) and the proxy key (Fkey) to the livestream device 7. The proxy key (Fkey) allows the server 6 to receive data (e.g., the image dataset (D2), the URL 91 and the audio-video data (D3) and the feedback dataset (D5)) at the proxy address. For example, the livestream device 7 uses the proxy key (Fkey) to encrypt the data to be transmitted to the proxy address (FID), and the server 6 verifies the data from the livestream device 7 using the proxy key (Fkey) that corresponds to the user account, and receives the data from the livestream device 7 only when verifying that the data is encrypted with the proxy key (Fkey); the server 6 may omit the data when otherwise.

In step S02, the livestream device 7 is logged in to the social media platforms 4 through verification, causing the server 6 to automatically request and obtain a plurality of stream keys (Tkey) respectively from the social media platforms 4, and a plurality of platform addresses (VID) respectively from the social media platforms 4, and to establish corresponding relationships among the stream keys (Tkey), the platforms addresses (VID), the proxy address (FID) and the proxy key (Fkey). Thereby, the livestream device 7 is enabled to intercommunicate with the social media platforms 4 through the server 6, so as to allow the livestream device 7 to obtain permission to access the social media platforms 4. Specifically, for each social media platform 4, the stream key (Tkey) obtained from the social media platform 4 is used for allowing the server 6 to livestream the streaming media (S) on the social media platform 4 based on the platform address (VID) obtained from the social media platform 4.

In the present embodiment, verifications are performed by inputting a user account and a password via the touch screen 72. It should be noted that the verifications are not limited to using the user account and the password. In variations of the present embodiment, the verifications may also done through credential verification, biometric verification, one-time password (OTP) verification, voice verification, etc.

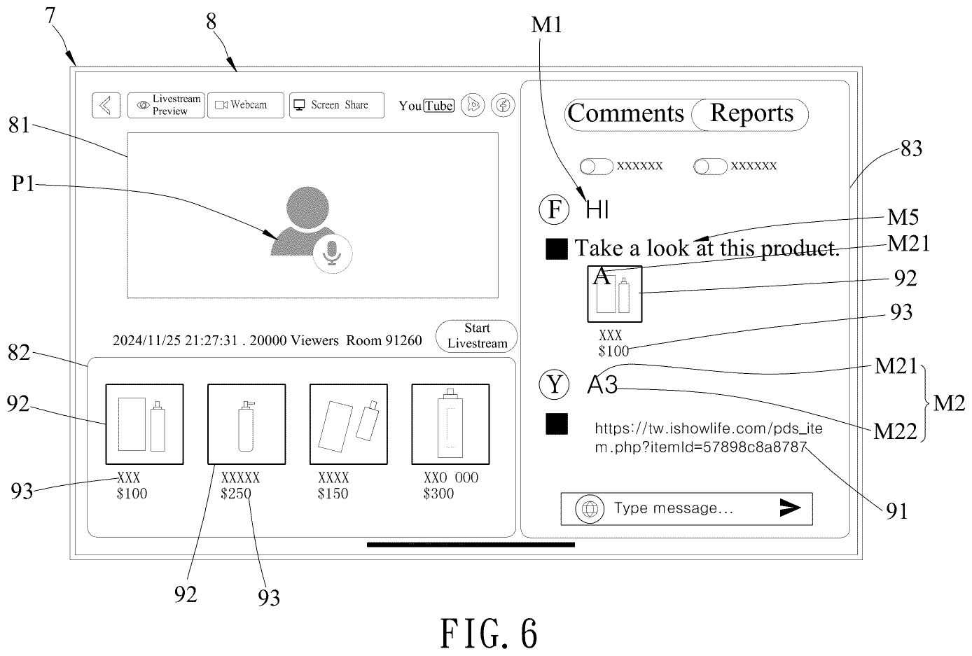

In step S03, the livestream device 7 obtains the image dataset (D2) for generating the product image 92 of the product and the set of product information 93, and the URL 91 of the transaction webpage 9, and displays the product image 92 and the set of product information 93 in the product preview area 82. As shown in FIG. 6, multiple product images 92 respectively of different products and multiple sets of product information 93 that correspond respectively to the different products are displayed in the product preview area 82.

It is worth noting that in the present embodiment, the image dataset (D2) is obtained by the server 6 from the shopping website through an application programming interface (API) that is defined by a set of specifications (protocol), and then transmitted to the livestream device 7.

In step S04, the livestream device 7 obtains an audio-video dataset (D3) for generating the first video (P1) with audio, and displays the first video (P1) in the video display area 81 of the control interface 8.

In step S05, the livestream device 7 uses the proxy key (Fkey) to transmit the data (i.e., the image dataset (D2), the URL 91, the audio-video dataset (D3), etc.) for representing the streaming media (S) to the server 6 for the server 6 to integrate the data for representing the streaming media (S), and to transmit the integrated data to the social media platforms 4 so as to livestream the streaming media (S) on the social media platforms 4 to the electronic devices 5. Each of the electronic device 5 plays video and/or audio (i.e., the streaming media (S)) by executing the integrated data. In this embodiment, the server 6 is configured to generate the video traffic report (M3) according to a number of times the audio-video dataset (D3) is executed.

In the present embodiment, the data that represents the streaming media includes, but is not limited to, the image dataset (D2), the URL 91, the audio-video dataset (D3), the feedback dataset (D5), or combinations thereof.

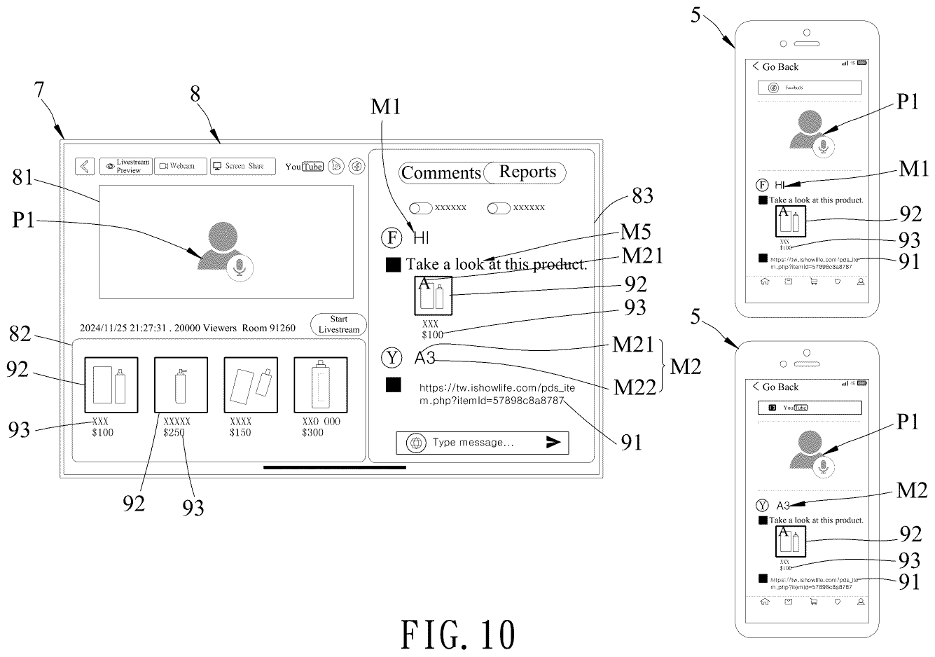

Since the server 6 has obtained the stream keys (Tkey) from the social media platforms 4, when the livestream device 7 displays the first video (P1) in the video display area, the streaming media (S) will also be livestreamed on the social media platforms 4. In this way, when viewers from around the world log in to the social media platforms 4 through the electronic devices 5 respectively, the viewers can browse the streaming media (S) substantially having the same content, as shown in FIG. 10.

In step S06, in response to one of the product images 92 in the product preview area 82 being selected by the livestream host, the selected product image 92 and the set of product information 93 corresponding to the product of the selected product image 92 are displayed in the information area 83. In addition, the first character (M21) representative of a selection order in which the selected product image 92 is selected is annotated on the selected product image 92 by the livestream device 7 and the server 6 based on the selection order. Then, as shown in step S05, the server 6 integrates the audio-video dataset (D3) and the image dataset (D2) into the streaming media (S).

For example, the product preview area 82 displays the product image 92 of a shampoo and the product image 92 of a body wash. When the product image 92 of the shampoo is selected first by the livestream host, the product image 92 of the shampoo and the set of product information 93 of the shampoo are displayed in the information area 83, with the first character (M21) of “A” annotated on the product image 92 of the shampoo. At the same time, when the electronic devices 5 livestream the streaming media (S), the viewers can browse on their electronic devices 5 the first video (P1), the product image 92 of the shampoo, which is annotated with “A”, and the set of product information 93 of the shampoo. Using as an example the social media platform 4 being embodied as Facebook, and one of the electronic devices 5 belonging to a viewer on Facebook, the electronic device 5 plays the first video (P1) through a media player embedded in a webpage, and displays in a comment area the product image 92 annotated with “A”. Then, when the product image 92 of the body wash is selected by the livestream host, the product image 92 of the body wash will be annotated with the first character (M21) “B”.

In step S07, the feedback dataset (D5) for generating the livestream host comment (M5) is inputted by the livestream host, and the livestream host comment (M5) is displayed in the information area 83 of the control interface 8. Then, in step S05, the server 6 integrates the audio-video dataset (D3), the image dataset (D2), and the feedback database (D5) into the streaming media (S).

In step S08, the livestream device 7 receives the communication data (D1) obtained and transmitted by the server 6, and displays the viewer comments (M1) and the transaction codes (M2) in the information area 83. In this way, the livestream host can browse in the information area 83 the viewer comments (M1) and the transaction codes (M2) coming from different social media platforms 4.

At the same time, when a viewer wishes to purchase the product (e.g., the shampoo) being sold, in addition to being able to directly click on the URL 91 through their own electronic device 5 to jump to the transaction webpage 9 corresponding to the URL 91 to purchase the product, the server 6 can also automatically update a shopping cart list on the transaction webpage 9 based on the transaction code (M2) without the electronic device 5 jumping to the transaction webpage 9. The shopping cart list includes the product name of the product, the purchase quantity corresponding to the second character (M22), and a unit price of the product. So as to not interrupt livestreaming of the streaming media (S) on the electronic device 5, after the livestreaming of the streaming media (S) is completed, checkout can be directly performed on the transaction webpage 9 without having to re-select the product and input the purchase quantity.

It is worth mentioning that the aforementioned automatic updating of the shopping cart list by the server 6 is performed under the premise that the server 6 has authority to access the shopping website.

In step S09, the livestream device 7 receives the report dataset (D4), and displays in the information area 83 a report, which is one of the video traffic report (M3), the sales report (M4), and a combined report of the video traffic report (M3) and the sales report (M4).

In this way, through the report, the livestream host can quickly see a popularity of the livestreaming of the streaming media (S), the total sales quantity of the product, and the total sales amount of the product.

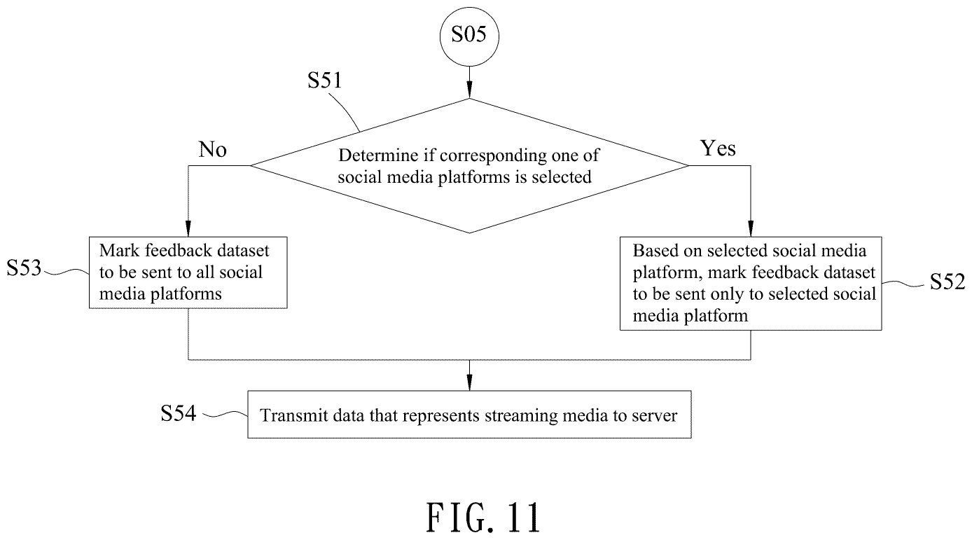

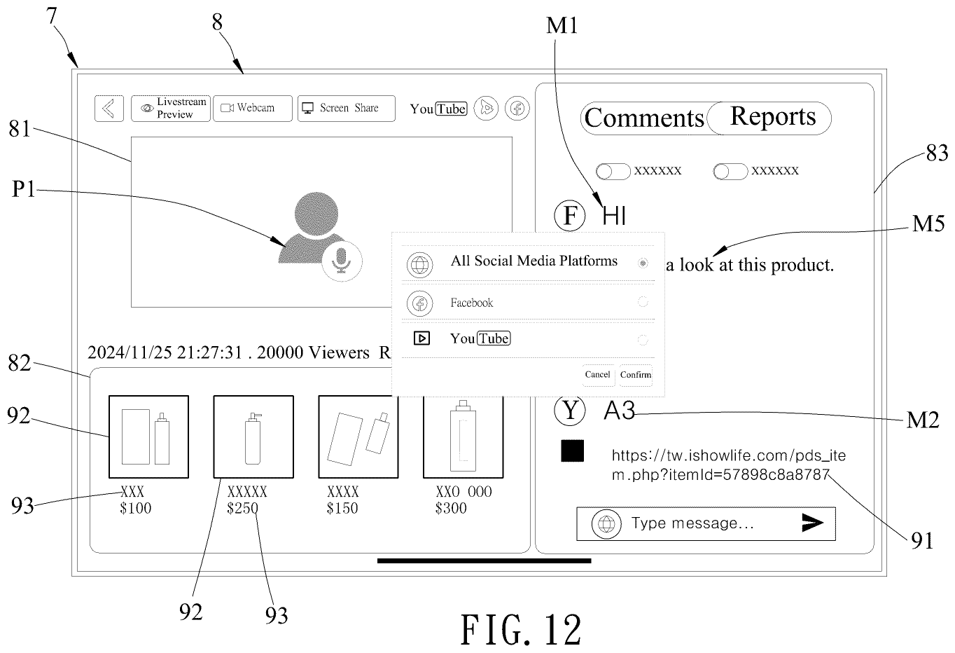

Referring to FIGS. 4, 10, 11 and 12, step S05 further includes sub-steps below.

In sub-step S51, the livestream device 7 determines if one or more of the social media platforms 4 (also referred to as “selected social media platform(s) 4”) is/are selected by the livestream host. In the present embodiment, the selected social media platform(s) 4 can be selected through the touch screen 72. If the determination is affirmative, a flow of the process proceeds to sub-step S52; otherwise, the flow proceeds to sub-step S53.

In sub-step S52, based on the selected social media platform(s) 4, the livestream device 7 marks the feedback dataset (D5) as needing to be sent only to the selected social media platform(s) 4. Then, sub-step S54 is performed.

In an example, the livestream host is logged in to the social media platforms 4 including YouTube, Facebook, X (formerly Twitter) and Instagram through the livestream device 7. When only the social media platforms 4 YouTube and Facebook are selected by the livestream host, only viewers viewing the streaming media (S) on YouTube and Facebook through electronic devices 5 corresponding thereto will be able to see the livestream host comment (M5). Viewers viewing the streaming media (S) on X and Instagram through the respective electronic devices 5 will not be able to see the livestream host comment (M5).

In sub-step S53, the livestream device 7 marks the feedback dataset (D5) as needing to be sent to all of the social media platforms. Then, sub-step S54 is performed.

In sub-step S54, the livestream device 7 transmits the data that represents the streaming media (S) to the server 6.

Thereby, the server 6 will, based on how the feedback dataset (D5) was marked by the livestream device 7, transmit the audio-video dataset (D3) to all of the social media platforms 4, and transmit the feedback dataset (D5) only to the selected social media platform(s) 4.

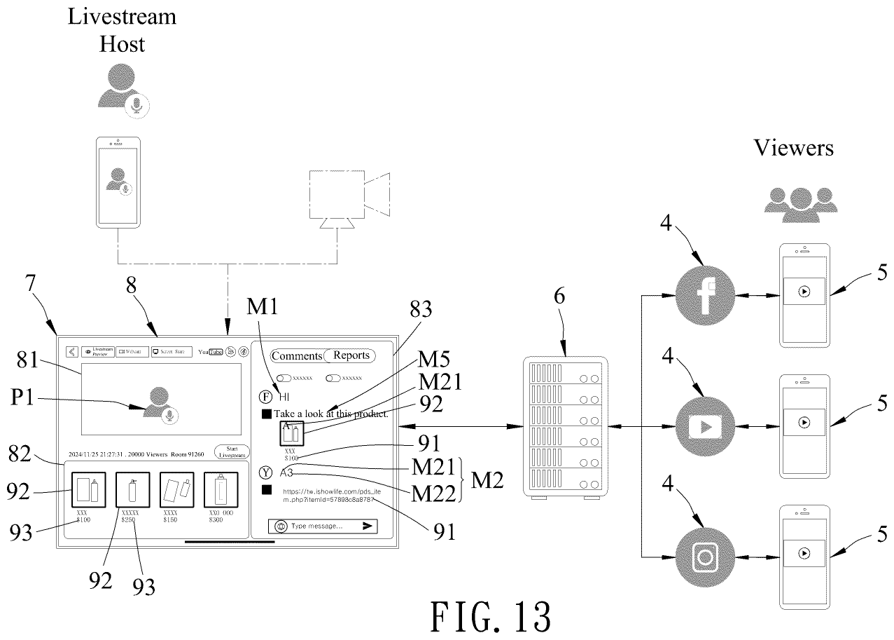

It should also be noted that the disclosure is not limited to using the front camera 73 of the livestream device 7 to obtain the first video (P1). In some embodiments, the first video (P1) may also be obtained using a smartphone or a video camera in intercommunication with the livestream device 7, as shown in FIG. 13.

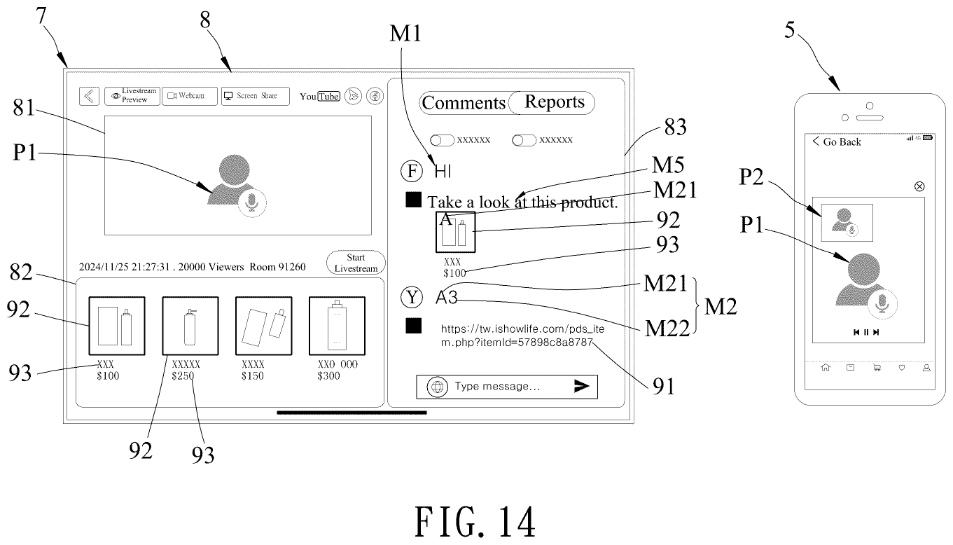

In addition, the disclosure is not limited to obtaining only the first video (P1). In some embodiments, as shown in FIG. 14, a second audio-video dataset (not shown) for generating a second video (P2) with audio may also be received through the communication unit 71. The second video (P2) may be a video of the viewer viewing the streaming media (S). The quantity of the second audio-video dataset is not limited to one, and may be two or three. Since the first video (P1) and the second video (P2) are both composed of multiple image frames, the server 6 further integrates the audio-video dataset (D3) and the second audio-video dataset by superimposing two layers of consecutive image frames respectively of the first video (P1) and the second video (P2) into one layer of consecutive image frames, and then transmits the one layer of consecutive image frames to a corresponding one of the social media platforms 4.

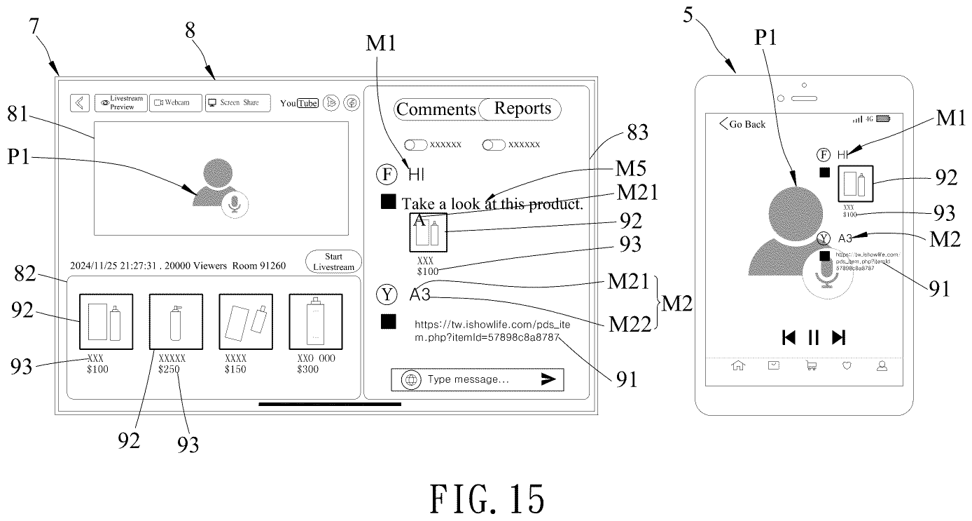

Similarly, referring to FIGS. 4 and 15, the server 6 can also further integrate the audio-video dataset (D3), the image dataset (D2), the communication dataset (D1) and the feedback dataset (D5) by superimposing the first video (P1), the product image 92, the set of product information 93 and the URL 91 into one layer of consecutive image frames, and then transmit the continuous layer of consecutive image frames to the corresponding one of the social media platforms 4. The server 6 may also superimpose into one layer of consecutive image frames the product image 92, the set of product information 93, the URL 91, all of the viewer comments (M1), all of the transaction codes (M2), all of the livestream host comments (M5), or combinations thereof, and then transmit the one layer of consecutive image frames to the corresponding one of the social media platforms 4. Thereby, the streaming media (S) can be played through a single media player in the embedded website of the social media platform 4.

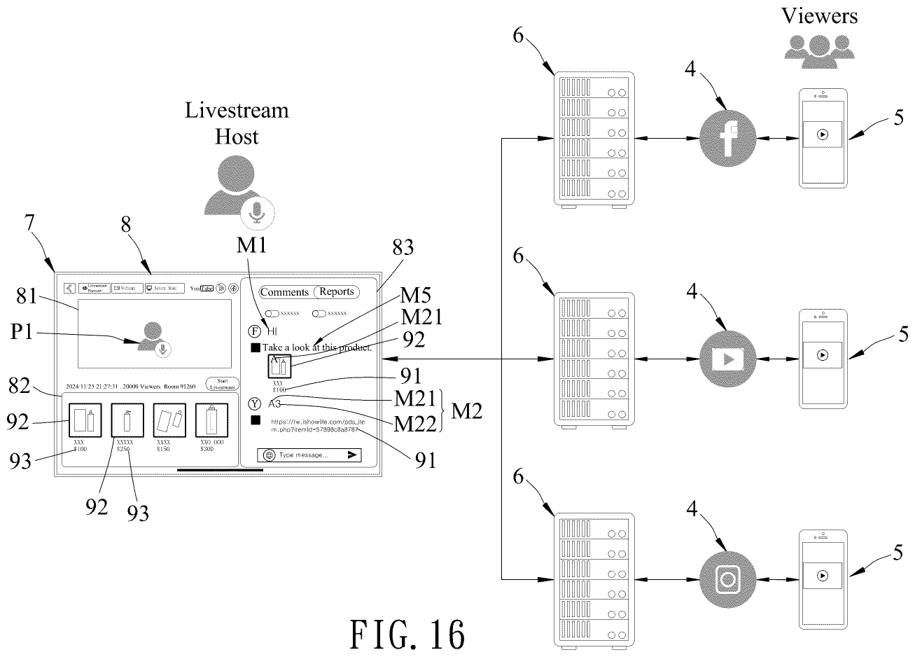

Moreover, referring to FIGS. 4 and 16, the system for cross-social media livestreaming may include a plurality of the servers 6 according to another embodiment of this disclosure. In this embodiment, each of the servers 6 is in intercommunication with the livestream device 7 and a respective one of the social media platforms 4, thereby providing more dedicated communication routes. For example, one of the servers 6 is only in intercommunication with one of the social media platforms 4, Facebook, and another one of the servers 6 is only in intercommunication with another one of the social media platforms 4, YouTube. Thereby, each of the servers 6 can be logged in to its respective one of the social media platforms 4 through its respective social media user account and its respective social media password, and automatically request and obtain from its respective one of the social media platforms 4 the stream key (Tkey) for livestreaming the streaming media (S). Furthermore, each of the servers 6 can also receive the communication dataset (D1) transmitted by its respective one of the social media platforms 4.

In summary, advantages of the aforementioned embodiments are as follows.

For the livestream host intending to livestream the streaming media (S) to a plurality of social media platforms 4, either only one livestream device 7, or a combination of at most one livestream device 7 and one image-capturing device is required for the livestream host to livestream the streaming media (S) to the plurality of social media platforms 4, and to view the viewer comments (M1) received from the plurality of social media platforms 4. Not only can this greatly increase the number of viewers, but equipment can be effectively simplified, time can be saved, and equipment costs can be reduced.

Since all datasets, including the communication dataset (D1), the image dataset (D2), the audio-video dataset (D3), the report dataset (D4) and the feedback dataset (D5), are displayed on the livestream device 7, the livestream host only needs to operate one livestream device 7. In this way, the livestream host can not only view all of the viewer comments (M1) from different ones of the social media platforms 4 without missing any of the viewer comments (M1), but the livestream host comment(s) (M5) can also be seen by viewers on different ones of the social media platforms 4, greatly improving communication efficiency.

Since a large amount of bandwidth is required for the social media platforms 4, if the streaming media (S) is directly livestreamed by the livestream device 7 on the plurality of social media platforms 4, the bandwidth will be insufficient for handling traffic several times that of the streaming media (S) livestreaming on only one social media platform, affecting smoothness of livestreaming and viewing. According to the disclosure, the server 6 can be used as a relay station to which data from the livestream device 7 can be transmitted in a one-on-one manner. The streaming media (S) can then be livestreamed in a one-to-many manner on the social media platforms 4 by the server 6, which has a bandwidth much larger than that of the livestream device 7. In this way, not only can the smoothness of livestreaming and viewing of the streaming media (S) be greatly improved, but the equipment costs of the livestream host can also be reduced.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for cross-social media livestreaming, to be implemented by a livestream device that is in intercommunication with a server and that is operated by a livestream host, the method comprising steps of:
logging in to the server and to a plurality of social media platforms by identifying the livestream host, so as to gain permission to access the server and the plurality of social media platforms;
obtaining an image dataset to be used for generating a product image of a product being sold, and a Uniform Resource Locator (URL) of a webpage for purchasing the product, and displaying the product image and the URL through a control interface, the image dataset and the URL being configured to represent a streaming media;
obtaining an audio-video dataset to be used for generating a video with audio, and displaying the video through the control interface, the audio-video dataset being configured to represent the streaming media;
transmitting the image dataset, the URL and the audio-video dataset to the server for the server to livestream the streaming media on the plurality of social media platforms, so as to enable a plurality of electronic devices to browse the streaming media through the plurality of social media platforms; and
receiving a communication dataset obtained by the server and to be used for generating a viewer comment, and displaying the viewer comment through the control interface, the communication dataset being transmitted to the server by one of the plurality of electronic devices through one of the plurality of social media platforms, the viewer comment including text, one or more symbols, one or more links, one or more graphics, or combinations thereof.

2. The method as claimed in claim 1, the control interface including a video display area for displaying the video, a product preview area for previewing the product image, and an information area for displaying the viewer comment,
wherein displaying the product image includes displaying the product image in the product preview area, and in response to the product image in the product preview area being selected by the livestream host, further displaying, in the information area, the product image and a first character that is annotated on the product image and that is representative of a selection order in which the product image is selected.

3. The method as claimed in claim 2, further comprising, after transmitting the image dataset, the URL and the audio-video data to the server:
generating a livestream host comment based on a feedback dataset inputted by the livestream host, and displaying the livestream host comment in the information area, the feedback dataset being configured to represent the streaming media, the livestream host comment including text, one or more symbols, one or more links, one or more graphics, or combinations thereof; and
further transmitting the feedback dataset to the server for the server to livestream the streaming media on the plurality of social media platforms in real time.

4. The method as claimed in claim 3, further comprising the sever transmitting the feedback dataset to one or more of the plurality of social media platforms.

5. The method as claimed in claim 3, further comprising the server integrating the audio-video dataset, and one of the image dataset, the communication dataset and the feedback dataset, so as to overlay one of the product image, the viewer comment and the livestream host comment onto the video.

6. The method as claimed in claim 2, further comprising, after obtaining the audio-video dataset and displaying the video through the control interface:
in response to the product image in the product preview area being selected, further displaying the URL in the information area.

7. The method as claimed in claim 6, further comprising generating and displaying on the control interface a transaction code to be used for purchasing the product based on the communication dataset, the transaction code including the first character corresponding to the product and a second character corresponding to a purchase quantity.

8. The method as claimed in claim 7, wherein the first character is an English letter, the second character is a numeral, the transaction code is one of a first string composed of the first character coming before the second character and a second string composed of the first character coming after the second character, and the second character is spaced apart from the first character by a predetermined number of preset characters in the transaction code.

9. The method as claimed in claim 8, further comprising the server automatically updating, based on the transaction code, a shopping cart list on a transaction webpage, the shopping cart list including a product name of the product, the purchase quantity corresponding to the second character, and a unit price of the product.

10. The method as claimed in claim 8, further comprising, after receiving the communication dataset and displaying the viewer comment through the control interface:
receiving a report dataset to be used for generating one of a video traffic report, a sales report, and a combined report of the video traffic report and the sales report, and displaying in the information area the one of the video traffic report, the sales report, and the combined report,
wherein the video traffic report is generated by the server calculating a number of views of the audio-video dataset, and presents a number of people who viewed the streaming media through each one of the plurality of social media platforms based on the number of views,
wherein the sales report is generated by the server identifying each time the first character of the transaction code appears, and the purchase quantity corresponding to the second character, and predicting a total sales quantity and a total sales amount of the product.

11. The method as claimed in claim 1, wherein obtaining the audio-video dataset and displaying the video through the control interface includes:
obtaining a first audio-video dataset to be used for generating a first video with audio, and displaying the first video through the control interface; and
obtaining a second audio-video dataset to be used for generating a second video with audio, the first audio-video dataset and the second audio-video dataset being configured to represent the streaming media.

12. The method as claimed in claim 1, wherein logging in to the server and to the plurality of social media platforms includes:
by logging in to the server, causing the server to create a proxy address and to generate a proxy key based on the proxy address, the proxy key allowing the server to receive the image dataset, the URL and the audio-video data at the proxy address; and
by logging in to the plurality of social media platforms, causing the server to automatically obtain a plurality of stream keys respectively from the plurality of social media platforms and a plurality of platform addresses respectively from the plurality of social media platforms, and to establish corresponding relationships among the plurality of stream keys, the plurality of platform addresses, the proxy address and the proxy key, wherein, for each social media platform of the plurality of social media platforms, a stream key obtained from the social media platform is used for allowing the server to livestream the streaming media on the social media platform based on a platform address obtained from the social media platform,
wherein, in transmitting the image dataset, the URL and the audio-video data to the server for the server to livestream the streaming media on the plurality of social media platforms, the image dataset, the URL and the audio-video data that represent the streaming media are transmitted to the proxy address, and then to the plurality of platform addresses through the server based on the plurality of stream keys that correspond to the proxy key.

13. A cross-social media livestream system, adapted to be used for livestreaming a streaming media through a plurality of social media platforms, the system comprising:
a server for livestreaming the streaming media on the plurality of social media platforms; and
a livestream device configured to be in intercommunication with the server and to be operated by a livestream host, and to implement the method as claimed in claim 1.
